(19) United States
(12) Patent Application Publication
(10) Pub. No.: US 2003/0120516 A1
(43) Pub. Date: Jun. 26, 2003

(54) Interactive record-keeping system and method

(76) Inventor: Douglas A. Perednia, Portland, OR (US)

Correspondence Address: MARGER JOHNSON & MCCOLLOM PC, 1030 SW MORRISON STREET, PORTLAND, OR, 97205, US

(21) Appl. No.: 10/300,672

(22) Filed: Nov. 19, 2002

Related U.S. Application Data
(60) Provisional application No. 60/339,845, filed on Nov. 19, 2001.

(51) Int. Cl. G06F 17/00; G06F 17/60; G06F 7/00

(52) U.S. Cl. 705/3; 707/104.1

(57) ABSTRACT

A medical record system has an electronic processing device coupled to a network, a database stored on the electronic processing device, and a form generator for creation of encounter form corresponding to a set of data fields. A communicator transmits the encounter form via the network to a remote location, the encounter form being structured to receive patient encounter information of a patient encounter at the remote location. A data capture device can electronically capture patient encounter information from the encounter form. The system can schedule events and monitor compliance therewith. As well, an interactive medical consent curator can create a consent form corresponding to a medical procedure. User inputs can be received and a session recorder employed to record a consent session.

### CROSS REFERENCE TO RELATED APPLICATIONS

This application claims priority to U.S. Provisional Application Serial No. 60/339,845, filed on Nov. 19, 2001 and incorporated herein by reference.

### BACKGROUND OF THE INVENTION

Patient medical information traditionally has been kept in paper-based medical records at a medical practice. Efforts have been made recently to digitalize medical records into what is commonly known as electronic medical record (EMR) systems.

However, EMR systems largely have been spurned by the medical community as difficult to use, physically cumbersome, time-consuming, and costly. Physicians generally have little time to learn how to use EMR systems compared to the simple pen-and-paper format.

Storage of patient information in electronic form facilitates data searching, trending, and other related benefits. However, EMR systems have provided no assistance to medical professionals in avoiding many common medical errors that can be detected by data monitoring and trending.

Traditional EMR systems, like the paper-based medical records that preceded them, generally have been stand-alone systems. A lack of integration has prevented use of patient data for epidemiological or other purposes.

Further, most EMR systems are intended for use by a physician or by medical office staff. A typical EMR system therefore fails to satisfy a patient's need for access to health information, be it historical or specific to a current medical condition.

### BRIEF DESCRIPTION OF THE DRAWINGS

The interactive record-keeping system and method disclosed herein will become more readily apparent from the following detailed description, which proceeds with reference to the drawings, in which:

FIG. 1 is a block diagram of a first embodiment of the present interactive record-keeping system;

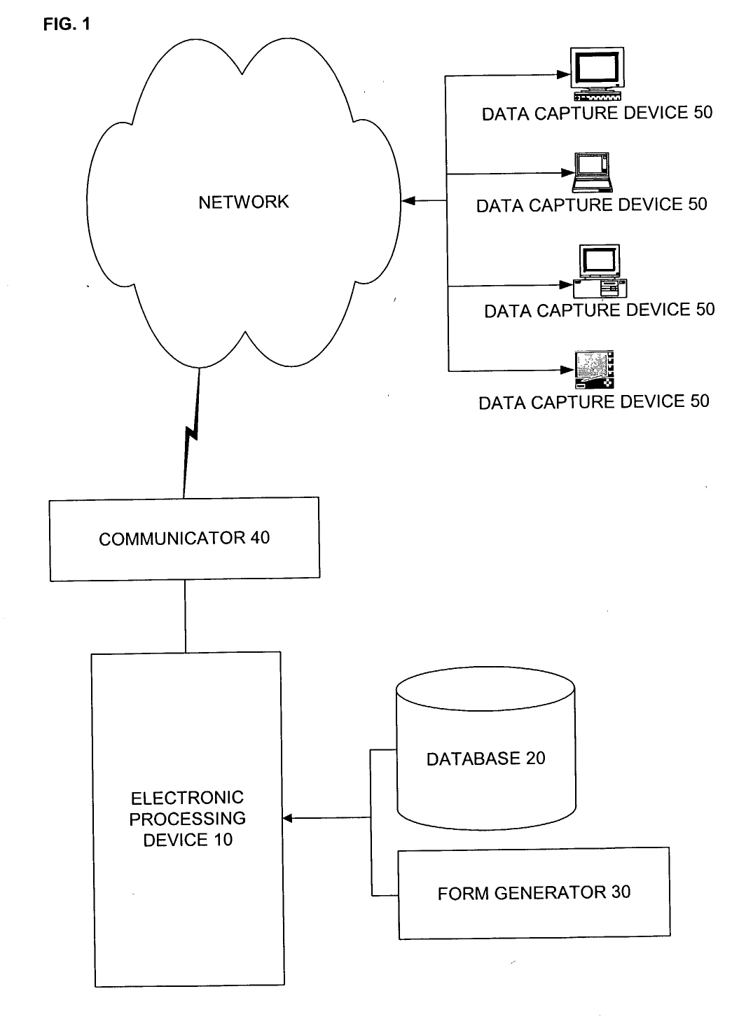

FIG. 2 is a block diagram of a second embodiment of the present system having a calendar element;

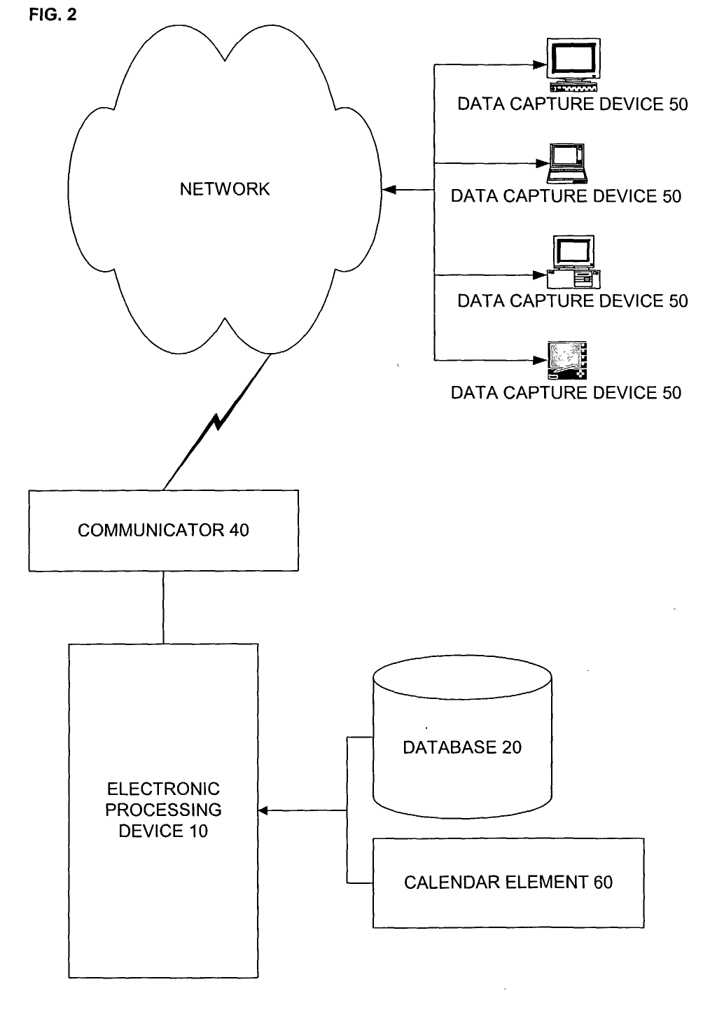

FIG. 3 is a block diagram of an alternative embodiment of the system of FIG. 2, further having a performance tracker;

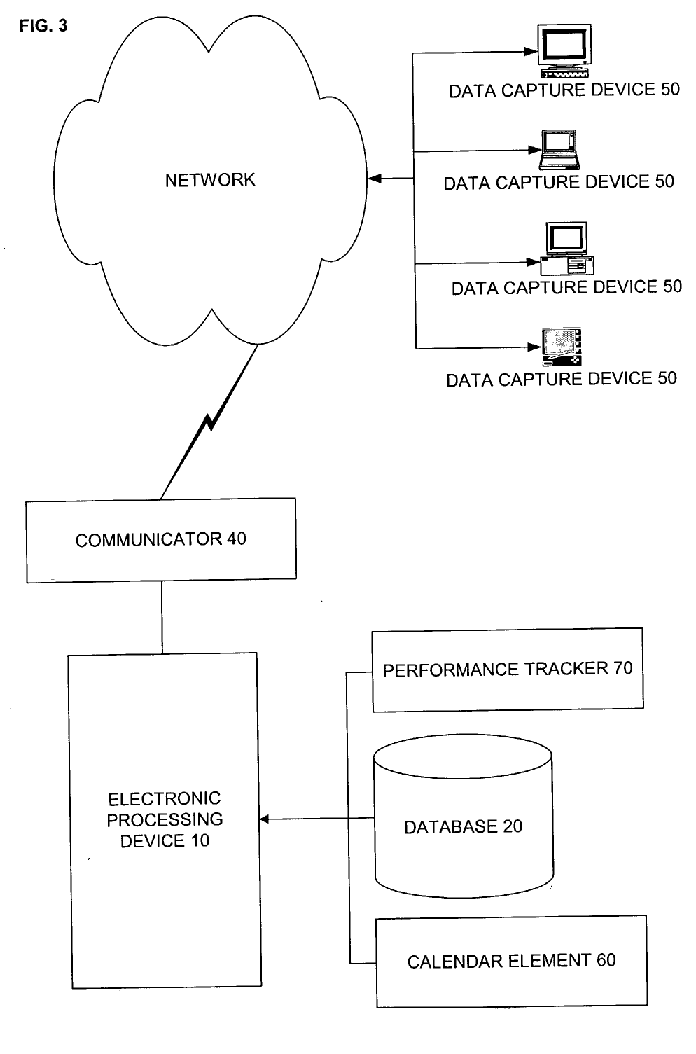

FIG. 4 is a block diagram of an alternative embodiment of the system of FIG. 1, further having a calendar element and a performance tracker; and

FIG. 5 is a block diagram of an interactive medical consent curator.

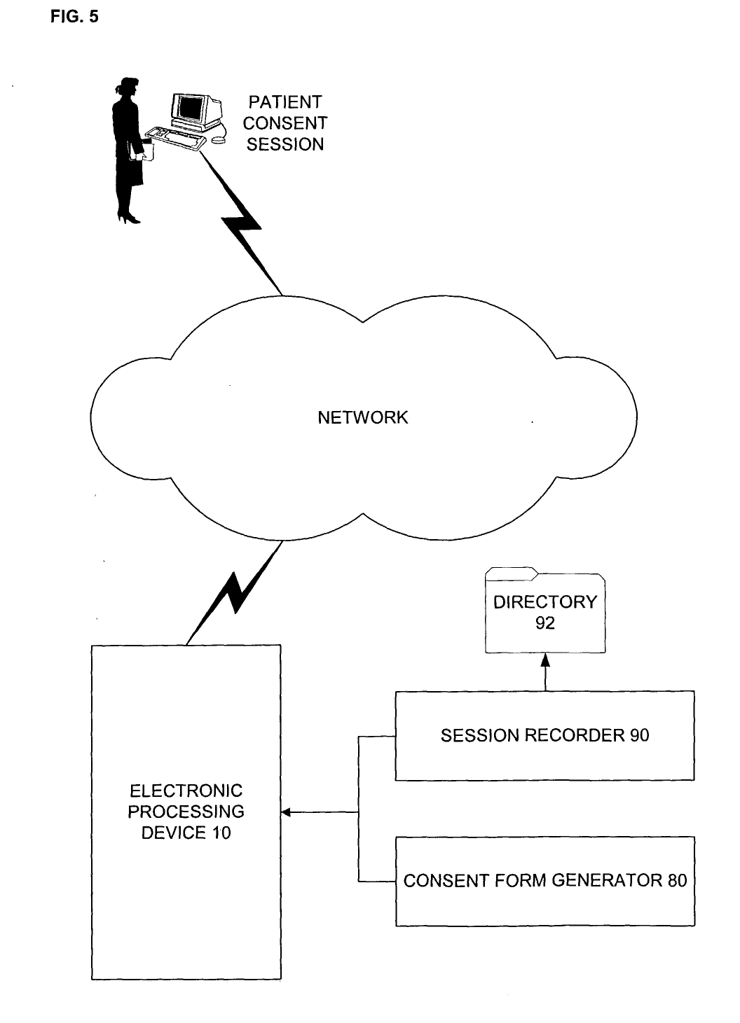

### DETAILED DESCRIPTION OF PREFERRED EMBODIMENT(S)

A interactive record-keeping system as described herein serves as a repository for medical information about patients. Similar in a basic way to conventional electronic medical record (EMR) systems, information generated during a healthcare provider visit can be inputted into such a system and stored in electronic form.

The present system is adapted to provide patients with health information specific to their current medical condition. The system also assists medical professionals in avoiding many common medical errors.

The system further is operative to produce encounter forms specific to each patient that can be customized for each clinician, practice, or specialty. Encounter forms allow clinicians to record information manually, from which data and images can be scanned into the system. Alternatively, information can be entered into the system manually or via an electronic device such as an electronic tablet, and the data then can be uploaded to the system.

Finally the system provides monitoring and statistical mechanisms to assist in the identification of various events and trends associated with health care.

The below description of preferred embodiments focuses on a system adapted for use in medical information management. It is readily understood that the present system efficaciously can be utilized in other arts An exemplary system provides a way to capture and store medical information of a patient, such as medical information entered into a patient record. Patient information typically is entered into a patient record by a health care provider, or agent thereof, during a patient encounter, i.e. a medical office or clinic visit, a hospital admission, an emergency room treatment or other such patient-care provider interaction.

The system includes an electronic processing device 10, such as a computer, coupled to a network. The network can be, among others, a local-area, wide-area or global network, or a wireless network such as a radio-frequency-based network.

The electronic processing device 10 can be of a type well-known in the art (e.g., desktop personal computer, laptop or notebook computer, personal digital assistant, cellular telephone or other electronic device) having a network interface.

A database 20 is coupled to the electronic processing device 10 and configured to contain a patient profile. The patient profile contains data of a type found in a patient medical record, but can include additional information.

A form generator 30 is operative to create an encounter form. The encounter form includes fields corresponding to a set of data fields. The encounter form is, in the present medical context, structured to be used by a care provider contemporaneous with a patient encounter.

The form generator 30 is operative to generate an encounter form that can present information and provide prompts or opportunities for data input by the care provider.

The form generator 30 is operative to present the fields of the encounter form in a variety of ways. For example, a data field can provide for a data input. The encounter form in a clinical setting typically is used to record patient information pertinent to the encounter. The encounter form therefore can be structured to receive an input corresponding to, for example, a measured physiological (e.g., weight, temperature, a lab test result), a patient complaint (e.g., a complaint of dizziness), a diagnosis (e.g., pneumonia), a prescription, or a notation regarding an examination or procedure.

Alternatively, a data field can be presented with data therein, such data being previously stored in the database 20. Presentation of data can be textual (that is, alphanumeric), graphic and/or audio.

Examples of data presentable to the care provider can include basic patient information, such as baseline physiological data including test results, recent illnesses, most recent encounter, current and/or prior prescribed medications, insurance information, contact information.

As well, secondary information can be presented to the care provider, for example, a reminder to perform a particular examination, make an inquiry of the patient, schedule a follow-up appointment at a future date or within a future date range, and so on.

A communicator 40 is provided, operative to transmit the encounter form via the network. In an embodiment of the present system wherein a user is located at a clinical site (e.g. remote device A-D) remote from the location of the electronic processing device, it is expedient to transmit an encounter form from the electronic processing device 10 over the network to the remote site.

The encounter form can be transmitted to the remote site electronically via the network. The encounter form can be configured for presentation to the user in a paper format (i.e., transmission in printable format). Alternatively, the encounter form can be structured to present and/or receive input via an electronic device (discussed in greater detail below).

The foregoing operation can be accomplished irrespective of the physical location of the electronic processing device 10 and the form generator 30. For example, a set of data fields can be communicated from the electronic processing device 10 to a user device at the remote location; a form generation module at the user device can then incorporate the set of data fields into an encounter form.

A data capture device 50 is configured to electronically capture encounter information from the encounter form. Information can take many forms, e.g. selection of a check box, click of an electronic button, text data entry, typed data entry.

Encounter information alternatively can be captured via direct entry into an electronic device, such as a computer, an electronic tablet, a touch screen, a digital assistant or other device employing optical character recognition, handwriting capture, a device using voice recognition, or other well-known devices.

In instances when the encounter form is used at the remote location in paper form, information can be captured by scanning of the paper document, utilizing optical character recognition, handwriting conversion and similar technologies known to those of ordinary skill in the art.

Captured encounter information likewise can be transmitted from the remote location to the electronic processing device 10. Encounter information then can be stored in the database for use in numerous ways, such as electronic archive of the patient's medical information, association with a patient profile, or data analysis for epidemiology or risk management purposes.

The form generator 30 further is operative to customize the encounter form by selection of data fields for inclusion in the set of data fields. The system thereby can adapt to the preferences, usage patterns and insurance requirements of various care providers, practice groups, and form needs vis-à-vis individual patients.

Selection can be made based on input from a user at the remote location at the time of set-up. For example, a user can be identified by medical practice type. The system can be instructed to select specific data fields based on generic practice profiles, such as dermatology, internal medicine, general practice, elder care, and so on.

As well, a user can actively alter the data fields after system set-up, to add or delete a specific data field. A particular user may, for example, have greater interest in the patient's current medication list than in the patient's contact information. The form generator 30 is operative to receive a user input and modify the content of an encounter form, either for the specific user, the specific practice group with which the user is associated, or the specific patient.

The form generator 30 further is operative to revise selection of data fields by detection of non-use of the data field. Non-use for a selectable time period or number of encounter form generations can be detected by the form generator 30, and the unused data field deselected to avoid presentation in subsequent encounter forms.

It is further preferred that the system be operative to communicate with other functional modules, such as a billing module, a scheduling module, or a remote database. The system therefore can support interfaces to other external medical information applications. The interfaces can provide bi-directional synchronization of data systems, including billing and scheduling (practice management) systems; laboratory information systems; hospital information systems; care guideline databases; medical content (e.g., drug) databases; insurance provider systems; imaging systems (X-ray, radiology, etc.); and existing electronic medical records systems.

Third-party databases physically remote from the system, such as a hospital or laboratory database, can contain patient medical data. Informational databases, e.g. a medical condition database or care guideline database, can be helpful for medical diagnosis, patient education and other uses. An insurance information database also can be useful in referrals to another physician or care facility, billing, or prescription of medication. Interaction of the system with a care guideline database is discussed more fully below.

The system further facilitates the prescription of medications by integrating the captured encounter information with manual and automated prescription mechanisms. In addition to the name of a medication, additional information, such as the dispense amount, number of refills, physician instructions, etc. can be scanned in from the medications field of the encounter form. Alternatively, the data may be entered directly via an other interface (e.g., a computer terminal). For refills, the system allows for identification of the original prescription, reducing the amount of data to be entered.

The system can generate prescriptions in a variety of ways: via a paper printout given to the patient contemporaneous with the encounter; via facsimile transmission directly to a pharmacy, or via electronic submission to a pharmacy possessing a compatible interface.

Health insurance companies also may have regulations concerning coverage of specific brands and types of medications. These rules are known as “formularies” and generally are varied and complex. The system can use the formularies for a health insurance carrier to determine which medications are preferably prescribed for a patient. Application of formularies reduces the time spent by physicians on follow-up of a prescription after its rejection by a pharmacy.

When a medication is prescribed for a given patient, the system can be configured to look up current prices for this medication at a plurality of pharmacies in the patient's local area. Pricing information will be compared, and the name of the lowest-cost options provided to the patient both on the prescription and on an information website accessible by the patient.

Medication rules can include comparison to a list of patient-incompatible drugs. Drugs on a patient-incompatible list typically are those to which a patient has a known or suspected allergy, drugs known or predicted to cause adverse interactions with a current patient medication, drugs incompatible with certain conditions (e.g. pregnancy), and so on.

A prescription output generally is a drug substitution or a user alert. Substitution can be of a generic drug for a prescribed branded drug. As well, one class of drug (e.g. antibiotic) can be substituted for another based on allergy data in the patient profile, potential interaction with a current medication of the patient, safety data, approval by the patient's medical insurer, drug cost or other data.

If an inputted drug prescription violates a medication rule of the set of medication rules, the system preferably will transmit a notice to the user and accept an alternative drug prescription for the patient. For some substitutions, such as generic for branded drug, this alert is normally not necessary. In other instances, such as where a potentially adverse drug interaction is detected, it is preferable that the substitution be at least approved by the user.

In the above preferred embodiment, the communicator 40 of the system further is operative to communicate with a pharmacy or other medication dispensing agent. Such communication enables the system to transmit a drug prescription output for a patient to the pharmacy.

The present system preferably is configured to operate as a database-backed web site executing on one or more computer systems. A user can access system services through a web browser from any location, using an encrypted, secure session. The web server can present to the user web pages containing data from one or more databases.

Operation of the system as described herein can proceed as follows. In a clinic or physician's office, a patient will appear for an appointment. Prior to or upon the patient's arrival, system-generated encounter forms (specifically designed for the clinician, practice or specialty) are printed by the clinic staff using the system. Encounter forms facilitate data capture without changing clinician workflow patterns or requiring the clinician to enter any of the data into a computer or other dedicated electronic device.

During the encounter, the patient is interviewed, physiological parameters are measured, diagnoses are made, procedures are performed or recommended, prescriptions are written, and so on. The physician will make note of these actions performed or recommended on the encounter form.

The encounter form provides a record of each diagnosis, procedure, lab test, medication, encounter note or image associated with the patient visit. For example, a female patient can be examined and tests performed to determine pregnancy. The system, via the encounter form, is operative to capture recordations by the user of a patient complaint, a lab test result, a sonagram image, and other data typically found in a patient chart.

The encounter form is scanned and each medical action taken or recommended during an appointment is captured in the system. As diagnosis, procedures, tests and medications accumulate, the system will suggest changes to the encounter forms for a specific clinician or practice based upon historical frequency (i.e., the form will be modified to include the most often used items).

On the basis of these actions, the system will present to the patient a set of medical content. The content is organized into a treatment plan for the patient. A treatment plan consists of diagnoses, tests, procedures, medications, and lifestyle recommendations. For each such element, a description is presented to the patient. This information can contain hyperlinks to related content. The system uses a practice key to identify different clinics where the patient has been seen. The patient is given the practice key for each practice and this enables the patient to see a composite of all records from each clinic regardless of location. The system has the capability to show each clinic all of the information from other clinics, if clinic policy permits.

A second embodiment of the present system is operative to monitor a medical event, such as a medical procedure, a subsequent patient encounter, a drug prescription or similar event.

The system according to this embodiment includes an electronic processing device 10 coupled to a network, a database 20 stored on the electronic processing device 10 and structured to store patient information, and a communicator 40 operative to transmit information via the network to a remote location.

This embodiment further includes a calendar element 60 operative to schedule an event. The event can be of single occurrence or recurring, the latter type either regularly or irregularly recurring in time.

The calendar element is further operative to assign a priority rating to the event. The priority rating can be based on a factor such as time or event category.

For example, the course of action for a patient diagnosed with pneumonia includes a chest X-ray approximately thirty days after initiation of treatment. The timing of this follow-up X-ray need not be exactly thirty days, however; the patient still can be properly treated if the follow-up chest X-ray is performed at 28 days or 33 days.

Conversely, for a patient prescribed a drug with potential side effects, such as liver damage, a drug tolerance assessment may be required at three days after initiation of drug therapy. The window of time in which this assessment can be performed is brief: there is a minimum time before most patients will begin to exhibit symptoms of drug intolerance, and a time after which the gravity of the side effects become significant. For events of such nature, the calendar element 60 is operative to assign a priority rating corresponding to the temporal flexibility of the event.

Similarly, some events are of critical importance in patient care, while others are in addition to a main course of treatment and are not mandatory to patient care. The calendar element 60 is operative to assign a priority rating based on an urgency of the scheduled event.

The temporal flexibility or urgency of an event can be determined from a look-up table, for example one stored in the database, or can be set by the user when the event is calendared.

In one embodiment, the system can determine a list of events to be scheduled for performance. This determination can be made on the basis of a diagnosis captured from the encounter form or other user input. The list of events can be determined from many sources, such as a care guideline database.

The system can be configured to transmit an event alert, reminder, or other signal to a user. The event alert can be transmitted at any time relative to the event. For example, a patient can be sent a reminder of an upcoming procedure. Conversely, for example, a clinician can receive an event alert when a scheduled event has not been recorded within a specified time by the system. Such docketing systems are well-known in the art.

Addressing more fully the care guideline databases mentioned above, many conditions have associated guidelines of care, including the generally accepted rules for medical treatment. A medical task or action also can have a guideline of care (GOC) associated therewith.

Care guidelines generally are established by recognized bodies such as the American Medical Association, but alternatively can be developed by other governing bodies or by a malpractice insurance entity.

More specifically, a GOC for a particular condition typically is a list of the medical tests, procedures, medications, follow-up examinations and lifestyle recommendations required for that condition. In addition, the GOC can contain scheduling information for appropriate tasks and events. For instance, statin drugs (used to treat high cholesterol levels) may cause adverse liver effects. It is therefore recommended that the liver function of a patient on statin drugs be regularly monitored, e.g. at 3- or 6-month intervals.

The system provides for use of a care guideline database. The care guideline database can be a dedicated element of the present system; alternatively, a third-party care guideline database can be accessible by the system. The operation of the system described herein uses detailed scheduling information in the GOC to provide a “To Do List” for physicians and patients.

Using the previous example, the GOC for a patient with pneumonia can require the chest X-ray, every 30 days for the next 90 days. The system can post a message on the To Do Lists for patient and physician to remind them of the necessity of the chest X-ray.

This item can remain on To Do Lists until dismissed by the physician, presumably because the X-ray has been performed, or until the completion of the X-ray procedure has been electronically captured from some other computer system such as a medical laboratory information system. Upon dismissal, a new item referencing the second required X-ray appears on the To Do Lists for the patient and physician. Irregular scheduling (e.g. at 30, 90 and 365 days) and infinitely repeating events can also be accommodated.

The calendar element also can schedule a reminder to the physician, patient or other user. Such reminder can be generated based on a relevant care guideline. Continuing the above pneumonia example, the calendar element 60 can cause a reminder to be transmitted to the patient concerning an upcoming X-ray requirement, a prescription refill or other event.

Alternatively, a reminder can be generated ad hoc, either set by a user or in response to detected data. An ad hoc reminder can be, e.g., a physician causing a reminder to be sent to a patient regarding fasting in the final twelve hours prior to a procedure. Detected data generating an alert can include detection by the system of completion of a To-Do List item or event. For example, the To-Do List for a patient can have a requirement for a follow-up visit at 14±3 days. Upon receiving a request for an encounter form for the patient's follow-up visit with the physician at 15 days, the system can determine that the follow-up event has been satisfied, and an event compliance message can be sent to the physician and/or the patient.

The calendar element 60 preferably is further operative to generate an alert in response to detection of an abnormal test result, e.g. a result value not within a normal value range or a user-selectable test value range.

For events such as blood work or some surgical procedures, the system will show a link to a published GOC for review by the patient or clinician. Patients thereby can be provided additional sources of information regarding their treatments and can better understand the bases for and participate in their courses of care.

By using a care guideline database, the system also provides physicians with assistance in patient treatment and risk management. The possibility of overlooking a component of reasonable care therefore is minimized. Further, physician or practice group performance can be tracked to detect activities in compliance or conflicting with the approved GOC. Such tracking can be performed for a physician, a practice group, or a plurality of physicians at disparate offices.

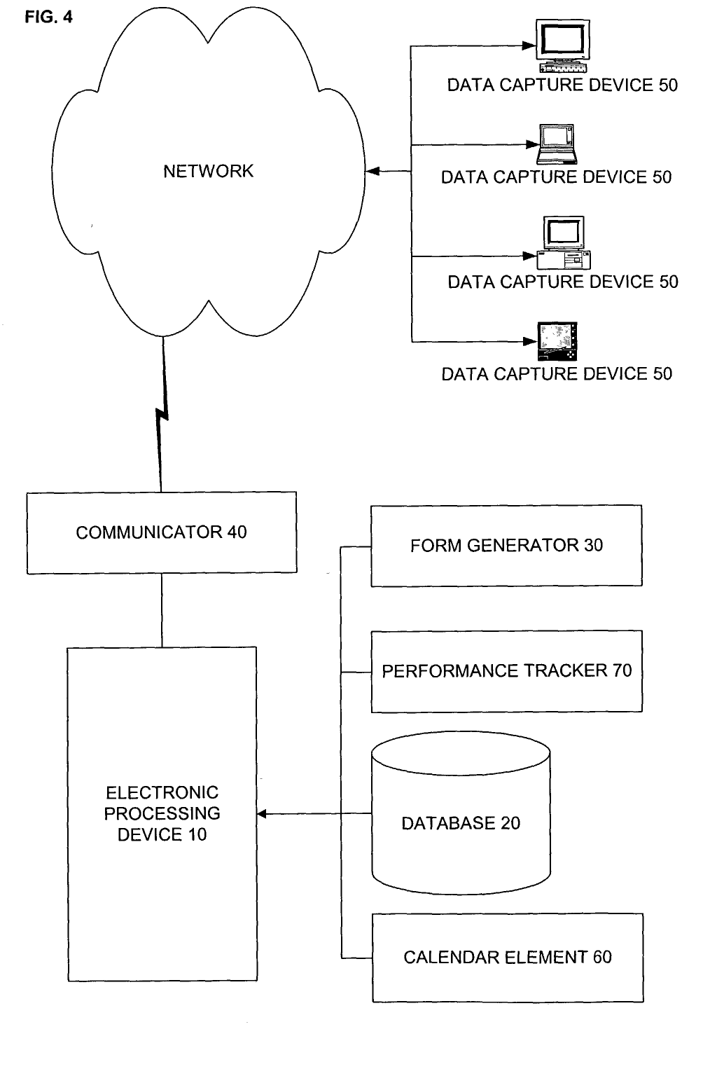

Compliance with GOC can be monitored on the basis of timing, omission of a recommended event, failure to follow-up or other criteria. The system, preferably through the performance tracker 70, is operative to produce a compliance report for one or more users, the compliance report corresponding an event occurrence with a scheduled event. The system as described can be combined with an encounter form generator 30 and a data capture device 50 (system, FIG. 4).

Any particular test or exam has validity beyond the exact date upon which the GOC indicates its necessity. In the above example, if the system may acquire notice of the first chest X-ray at 29 days or 31 days, rather than exactly at 30 days after the original diagnosis. Such a situation is perfectly reasonable and satisfies the intent of the GOC entry.

Therefore, each event contained within a GOC includes a priority rating, which can be thought of as a “window of effectiveness”. This rating defines the date range in which a test or exam will satisfy the requirements of a GOC entry. Continuing with the example, if the window of effectiveness for a chest X-ray is 5 days, then any chest X-ray performed within a range of (30−5) to (30+5) days will satisfy the 30-day chest X-ray event.

In many cases, a required test or exam becomes more urgently required as time passes beyond the date indicated by the guideline. The system provides for escalating the priority of a To Do List item as time passes. A specific test or exam contained within a GOC can have associated with it an Urgent and/or a Critical rating, corresponding to a number of days indicator. Suppose, for example, that the Urgent indicator for a subsequent examination is 10 days, and the Critical indicator is 25 days. At (30+10) days after the original diagnosis requiring the subsequent examination at 30 days, an unsatisfied To Do List item for the subsequent examination becomes rated as “Urgent”, and is so indicated on the To Do List. At (30+25) days past the original diagnosis, an unsatisfied To Do List item becomes rated as “Critical” and then is so indicated on the To Do Lists.

Based on scheduling issues or medical judgment, a physician may choose to postpone a test or exam. The system allows the physician to move the due date of a To Do List item associated with that test or exam to some future date. This can be used to accommodate re-scheduling of tests for a variety of reasons, such as vacations. A physician is not restricted to the GOC but can cancel a To Do List item if the physician's individual judgment so warrants.

An explicit, signed consent from a patient is legally required prior to performing some medical procedures or prescribing some medications. An interactive medical consent curator includes electronic processing device 10 coupled to a network and is configured to present medical consent information to a user.

A consent form generator 80 is operative to create a consent form requiring a user input receivable from the user. The consent form is designed to contain medical consent information corresponding to a medical procedure, medication or laboratory test. Such information typically includes information on the process, risks inherent in and alternatives to such procedure.

The curator preferably is configurable to electronically present to the patient an interactive informed consent form in any of several formats, among them a web page or an audio/audiovisual presentation. As with paper-based consent forms, the interactive informed consent form will describe the procedure, risks, benefits, expected outcome, etc. The interactive informed consent form will provide the patient with the same basic information as a paper-based informed consent form. This will allow the patient to become truly informed about the procedure or medication.

A session recorder 90 is operative to record a consent session, that is, a session wherein medical consent information is communicated to a patient and consent requested of the patient. Recordation of the consent session facilitates medical practice risk reduction, permitting a medical practitioner user to retain objective evidence that the relevant information and risks were presented to the patient.

Structuring of the presentation of medical consent information, as interactive rather than passive involves the patient in the process and encourages the patient to carefully read the interactive informed consent form, leading to increased remembrance and understanding of the presented information. The curator preferably is further operative to record user input from the user during the consent session.

The consent form generator 80 preferably produces a consent form structured to require one or more user inputs from a patient user. In one embodiment, the medical consent information can be separated into modules; upon display of the first module, a user input is required before presentation of each subsequent module (i.e., parcel of consent information) to the user.

User input can also take the form of a user query. For example, a block of information can be presented to the patient, followed by a choice of input options such as “I Understand” or “I Do Not Understand”. Selection of the latter option can produce, using a web-based example, a page prompting the patient to specify the unclear point(s) of the presented information.

This prompt can be a simple email dialog box, or the presented information can be re-presented in subunits, to determine specifically which portion is unclear to the patient. Transmission of a patient query tied to a specific quantum of consent information permits the patient's physician to focus a discussion on that aspect of the procedure, more completely informing the patient.

As well, a physician can be notified of any completion actions on the interactive informed consent form or whether the consent form has not been completed by the patient prior to a consent due date.

The exemplary input options, above, can be simple checkboxes or text input fields, the latter requiring the user to type or otherwise enter specific text in order to continue the consent session. An input also can be in the form of speech recognition or handwriting capture, if the patient's device is so equipped. Such input methodologies are well-known in the art.

The session recorder 90 preferably is further operative to include a chronological indicator. The chronological indicator can be used to determine the date and time a patient participated in a consent session to which the indicator is associated.

Each interactive informed consent form in a web-based format includes multiple text sections, e.g., a description of the procedure, patient preparation, attendant risks, etc. All such text sections can be displayed in a single web page. The web-based consent form preferably is structured for ease of patient understanding.

A single medication may be used to treat multiple conditions, and a single test may be used to diagnose different conditions. The content of a consent document is necessarily different in these different scenarios. The system allows for a single medication or procedure to have multiple interactive informed consent forms.

In the case where a patient is prescribed such medication or asked to undergo such a procedure, the system can dynamically determine the appropriate interactive informed consent form(s). Preferably, the system determines an appropriate informed consent form based on associations of informed consent forms with specific medical procedures, medications and the like.

Another aspect of the present system is the capability to capture a user's consent session for archival. The consent session can be replayed at a later point in time to indicate the information presented, as well as the actions taken by the pertinent system users. For example, the system can replay a patient's session to determine that the patient did indeed review some important set of information provided by the physician concerning that patient's diagnoses, medications, procedures, etc.

To accomplish this session capture, the system can write each consent form as an HTML page both to an HTTP session to be delivered to the user's browser and to a file on a consent database 20. Each such file preferably is stored in a directory 92 unique to the user consent session and further can be named by the date-time that the HTML page was sent to the patient's browser. In addition, when a user enters and posts data into HTML forms to the server, the curator writes the entered data into a similar file. Thus, at the end of the consent session, the directory 92 contains a complete set of the HTML files sent to the browser and inputs received from the patient's browser.

The curator additionally can provide a web site or other informational venue for patient information and education, as well as a secure messaging system is available for practitioners and patients. A secure web-based message system is preferable for the exchange of medical information due to privacy issues regarding individuals' medical information. In order to provide notifications of new messages without requiring constant checking of a customized patient web site, the messaging system can send a link to the patient web site message center via traditional email. Alerts also can be sent via known channels, including but not limited to paging and wireless text and/or audio messaging.

To make the communication of standard test results and other information more efficient, the system preferably contains a set of document templates that can be used with the messaging system. The templates can be linked with a lab result system and can allow different documents to be sent, for example based on whether the lab results are within normal acceptable ranges or not. The document templates can be configured for electronic messaging as well as via printed or faxed copies.

A person skilled in the art will be able to practice the present invention in view of the description present in this document, which is to be taken as a whole. Numerous details have been set forth in order to provide a more thorough understanding of the invention. In other instances, well-known features have not been described in detail in order not to obscure unnecessarily the invention.

While embodiments of the invention have been disclosed in specific forms, the specific embodiments thereof as disclosed and illustrated herein are not to be considered in a limiting sense. Indeed, it should be readily apparent to those skilled in the art in view of the present description that the invention can be modified in numerous ways. The inventor regards the subject matter of the invention to include all combinations and subcombinations of the various elements, features, functions and/or properties disclosed herein.

What is claimed is:

1. A medical record system, comprising:
an electronic processing device coupled to a network;
a database stored on the electronic processing device;
a form generator operative to create an encounter form corresponding to a set of data fields;
a communicator operative to transmit the encounter form via the network to a remote location, the encounter form structured to receive patient encounter information of a patient encounter at the remote location; and
a data capture device configured to electronically capture patient encounter information from the encounter form.

2. The system of claim 1 wherein the encounter form is adapted to receive information from a care provider contemporaneous with a patient encounter.

3. The system of claim 1 wherein the electronic processing device is operative to present textual and/or graphical data to a user device at a remote location via the network.

4. The system of claim 1 wherein the encounter form is an electronic form.

5. The system of claim 4 wherein the data capture device is an electronic tablet.

6. The system of claim 1 wherein the encounter form is paper form.

7. The system of claim 1 wherein the data capture device includes a scanner.

8. The system of claim 7 wherein the scanner is operative to optically recognize handwriting.

9. The system of claim 7 wherein the scanner is operative to detect a selected check box on a paper form.

10. The system of claim 1 wherein the form generator is operative to select data fields for inclusion in the set of data fields based on input from a user at the remote location.

11. The system of claim 10 wherein the form generator is operative to select data fields for inclusion in the set of data fields based on a profile associated with the remote location.

12. The system of claim 11 wherein the form generator is operative to select data fields for inclusion in the set of data fields based on a profile associated with a user at the remote location.

13. The system of claim 10 wherein the form generator is operative to select data fields for inclusion in the set of data fields based on a profile associated with a patient.

14. The system of claim 1 wherein the electronic processing device is operative to assemble medical information to be presented to the patient.

15. The system of claim 14 wherein content of the medical information correlates with data in a profile associated with the patient.

16. The system of claim 1 wherein the electronic processing device is operative to communicate with a billing module, a scheduling module, or a remote database.

17. The system of claim 16 wherein the remote database contains medical data of a patient.

18. The system of claim 16 wherein the remote database contains medical condition data.

19. The system of claim 16 wherein the remote database contains care guideline data.

20. The system of claim 16 wherein the remote database contains insurance data.

21. The system of claim 1 wherein the communicator is further operative to communicate with a pharmacy.

22. The system of claim 21 wherein the communicator is further operative to communicate a drug prescription for a patient to the pharmacy.

23. The system of claim 22 wherein the drug prescription is selected from a plurality of prescribable drugs stored in association with a profile of the patient.

24. The system of claim 23 wherein the profile of the patient is a pharmaceutical profile of the patient.

25. The system of claim 23 wherein the profile of the patient is an insurance profile of the patient.

26. The system of claim 1 wherein:
the electronic processing device is operative to receive a prescription input corresponding to a prescribed drug for a patient and apply a patient prescription rule set to produce a prescription output; and
the communicator is further operative to communicate the prescription output to a pharmacy.

27. The system of claim 26 wherein the patient prescription rule set includes a list of patient-incompatible drugs.

28. The system of claim 27 wherein the patient prescription rule set includes a list of drugs to which the patient is allergic.

29. The system of claim 27 wherein the patient prescription rule set includes a list of drugs incompatible with a contemporaneous prescription drug list for the patient.

30. The system of claim 26 wherein the patient prescription rule set includes a list of alternative prescribed drugs for the prescribed drug.

31. The system of claim 22 wherein the patient prescription rule set includes a list of prescribed drugs approved by an insurer of the patient.

32. A medical event monitoring system, comprising:
an electronic processing device coupled to a network;
a database stored on the electronic processing device and structured to store patient information;
a communicator operative to transmit information via the network to a remote location; and
a calendar element operative to schedule an event.

33. The system of claim 32 wherein the event includes a medical procedure.

34. The system of claim 32 wherein the event includes a subsequent patient encounter.

35. The system of claim 32 wherein the event includes a drug prescription.

36. The system of claim 32 wherein the calendar element is operative to schedule a recurring event.

37. The system of claim 36 wherein the calendar element is operative to schedule a regularly recurring event.

38. The system of claim 36 wherein the calendar element is operative to schedule an irregularly recurring event.

39. The system of claim 36 wherein the calendar element is further operative to assign a priority rating to the event.

40. The system of claim 39 wherein the priority rating is based on time.

41. The system of claim 39 wherein the priority rating is based on event category.

42. The system of claim 39 wherein the communicator is further operative to signal non-occurrence of an event within a specified time period to a user.

43. The system of claim 32 wherein the calendar element is operative to schedule an event based on input from a user.

44. The system of claim 32 wherein the calendar element is operative to schedule an event based on information captured from an encounter form.

45. The system of claim 32 wherein the calendar element is operative to schedule an event based on a care guideline profile.

46. The system of claim 45 wherein the care guideline profile includes a medical procedure.

47. The system of claim 45 wherein the care guideline profile includes a subsequent patient encounter.

48. The system of claim 45 wherein the care guideline profile includes a drug prescription.

49. The system of claim 45 wherein the care guideline profile includes a patient communication.

50. The system of claim 49 wherein the care guideline profile includes a patient reminder.

51. The system of claim 45, further comprising a performance tracker operative to monitor compliance of event occurrence with a scheduled event.

52. The system of claim 32, further comprising a performance tracker operative to monitor compliance of event occurrence with a scheduled event within a specified time period.

53. The system of claim 52 wherein the performance tracker is further operative to generate a compliance report for a user, the compliance report corresponding an event occurrence with a scheduled event.

54. The system of claim 32, further comprising:
a form generator operative to create an encounter form corresponding to a set of data fields; and
a data capture device configured to electronically capture patient encounter information from the encounter form; wherein
the communicator is further operative to transmit the encounter form via the network to a remote location, the encounter form structured to receive patient encounter information of a patient encounter at the remote location.

55. The system of claim 54 wherein the calendar element is operative to schedule an event based on patient encounter information electronically captured from the encounter form.

56. An interactive medical consent curator, comprising:
an electronic processing device coupled to a network and configured to present medical consent information to a user;
a consent form generator operative to create a consent form requiring a user input receivable from the user, the consent form corresponding to a medical procedure; and
a session recorder operative to record a consent session.

57. The medical consent curator of claim 56 wherein the session recorder is further operative to record the user input from the user.

58. The medical consent curator of claim 56 wherein the consent form generator is operative to create a consent form requiring a plurality of user inputs.

59. The medical consent curator of claim 56 wherein the electronic processing device is operative to require a user input before presentation of the consent information to the user.

60. The medical consent curator of claim 59 wherein the electronic processing device is operative to present a first portion of the consent information to the user and require a user input before presentation of a second portion of the consent form.

61. The medical consent curator of claim 56 wherein the user input includes a checkbox.

62. The medical consent curator of claim 56 wherein the user input includes a text input.

63. The medical consent curator of claim 56 wherein the user input includes a voice input.

64. The medical consent curator of claim 56 wherein the user input includes a written input.

65. The medical consent curator of claim 56 wherein the consent session includes the consent form and the user input.

66. The medical consent curator of claim 65 wherein the consent session further includes a chronological indicator.
